(19) United States
(12) Patent Application Publication
(10) Pub. No.: US 2021/0302975 A1
(43) Pub. Date: Sep. 30, 2021

(54) SYSTEMS AND METHODS FOR PREDICTING ROAD-AGENT TRAJECTORIES IN TERMS OF A SEQUENCE OF PRIMITIVES

(71) Applicant: Toyota Research Institute, Inc., Los Altos, CA (US)

(72) Inventors: Stephen G. McGill, JR., Broomall, PA (US); Guy Rosman, Newton, MA (US); Xin Huang, Cambridge, MA (US); Jonathan DeCastro, Arlington, MA (US); Luke S. Fletcher, Cambridge, MA (US); John Joseph Leonard, Newton, MA (US)

(21) Appl. No.: 16/830,762

(22) Filed: Mar. 26, 2020

(51) Int. Cl. G05D 1/02; G01S 19/39; G01S 13/58; G01S 13/931; G06N 3/08

(52) U.S. Cl. CPC G05D 1/0214; G01S 19/393; G01S 13/58; G05D 2201/0213; G05D 1/0221; G06N 3/08; G01S 2013/9321; G01S 13/931

(57) ABSTRACT

Systems and methods for predicting a trajectory of a road agent are disclosed herein. One embodiment receives sensor data from one or more sensors; analyzes the sensor data to generate a predicted trajectory of the road agent, wherein the predicted trajectory includes a sequence of primitives, at least one primitive in the sequence of primitives having an associated duration that is determined in accordance with a dynamic timescale; and controls one or more aspects of the operation of an ego vehicle based, at least in part, on the predicted trajectory of the road agent.

### TECHNICAL FIELD

The subject matter described herein generally relates to vehicles and other types of road agents and, more particularly, to systems and methods for predicting road-agent trajectories in terms of a sequence of primitives.

### BACKGROUND

In a variety of applications, including, for example, adaptive cruise control (ACC) systems, advanced driver-assistance systems (ADAS), parallel-autonomy vehicles, semi-autonomous vehicles, and autonomous vehicles, the need arises to predict the future behavior of road agents (vehicles, motorcycles, bicycles, scooters, pedestrians, etc.) and/or the ego vehicle itself, if the ego vehicle is at least partially under manual, human control. A variety of behavior-estimation techniques exist, including those that employ a physics-based model, those that employ one or more machine-learning-based models, and those that employ a combination of physics-based models and machine-learning-based models.

### SUMMARY

An example of a system for predicting a trajectory of a road agent is presented herein. The system comprises one or more sensors, one or more processors, and a memory communicably coupled to the one or more processors. The memory stores a prediction module including instructions that when executed by the one or more processors cause the one or more processors to receive sensor data from one or more sensors. The prediction module also includes instructions that when executed by the one or more processors cause the one or more processors to analyze the sensor data to generate a predicted trajectory of the road agent, wherein the predicted trajectory includes a sequence of primitives, at least one primitive in the sequence of primitives having an associated duration that is determined in accordance with a dynamic timescale. The memory also stores a control module including instructions that when executed by the one or more processors cause the one or more processors to control one or more aspects of the operation of an ego vehicle based, at least in part, on the predicted trajectory of the road agent.

Another embodiment is a non-transitory computer-readable medium for predicting a trajectory of a road agent and storing instructions that when executed by one or more processors cause the one or more processors to receive sensor data from one or more sensors. The instructions also cause the one or more processors to analyze the sensor data to generate a predicted trajectory of the road agent, wherein the predicted trajectory includes a sequence of primitives, at least one primitive in the sequence of primitives having an associated duration that is determined in accordance with a dynamic timescale. The instructions also cause the one or more processors to control one or more aspects of the operation of an ego vehicle based, at least in part, on the predicted trajectory of the road agent.

In another embodiment, a method of predicting a trajectory of a road agent is disclosed. The method comprises receiving sensor data from one or more sensors. The method also includes analyzing the sensor data to generate a predicted trajectory of the road agent, wherein the predicted trajectory includes a sequence of primitives, at least one primitive in the sequence of primitives having an associated duration that is determined in accordance with a dynamic timescale. The method also includes controlling one or more aspects of the operation of an ego vehicle based, at least in part, on the predicted trajectory of the road agent.

### BRIEF DESCRIPTION OF THE DRAWINGS

So that the manner in which the above-recited features of the present disclosure can be understood in detail, a more particular description of the disclosure, briefly summarized above, may be had by reference to the implementations, some of which are illustrated in the appended drawings. It is to be noted, however, that the appended drawings illustrate only possible implementations of this disclosure and are therefore not to be considered limiting of its scope. The disclosure may admit to other implementations.

FIG. 1 illustrates one embodiment of a vehicle within which systems and methods disclosed herein may be implemented.

FIG. 2 illustrates one embodiment of a trajectory prediction system.

FIG. 3 illustrates a scenario in which a road-agent trajectory is predicted in terms of a sequence of primitives having a dynamic timescale, in accordance with an illustrative embodiment of the invention.

FIG. 4 is a flowchart of a method of predicting a trajectory of a road agent, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments described herein provide improved estimation of the behavior of a road agent over a potentially longer time horizon by analyzing future road-agent trajectories in terms of a sequence of primitives. In this context, a driving “primitive” is a driving maneuver that occurs frequently, such as, without limitation, starting, stopping, following another road agent, passing another road agent, turning left, turning right, changing lanes, and making a U-turn. A road agent's behavior over a flexible time horizon of from a few seconds to a minute or more can be modeled as an ordered sequence of such primitives. For example, the behavior of a vehicle approaching a red light at an intersection could be analyzed and predicted as a sequence of primitives such as “decelerating from 30 mph to a stop over the next five seconds,” “waiting at the traffic signal until it changes state from red to green,” “accelerating from a stop to 30 mph over five seconds after the light changes to green,” and “proceeding straight at 30 mph for ten seconds.”

One important aspect of the embodiments described herein is that at least some of the primitives in a sequence of primitives have an associated duration that is determined in accordance with a dynamic timescale. That is, the duration associated with the primitive can be dynamic or flexible because it depends upon one or more predetermined conditions being satisfied. For example, a primitive such as “stopping at intersection until road agent in cross-traffic passes by” has a dynamic timescale because the ultimate duration of such a primitive depends on how long it takes for a condition to be satisfied—i.e., how long it takes the road agent in cross-traffic to pass by.

In some embodiments, the system estimates the behavior of a road agent (e.g., a vehicle, a motorcycle, a bicycle, a scooter, a pedestrian, etc.) external to an ego vehicle. In other embodiments, the system estimates the behavior of an ego vehicle itself (i.e., the road agent and the ego vehicle are one and the same vehicle), if the ego vehicle is, at least partially, manually driven by a human driver. Once a road agent's behavior (e.g., its trajectory in terms of a sequence of primitives) has been predicted, the system can control one or more aspects of the operation of the ego vehicle based, at least in part, on the predicted road-agent trajectory. Herein, a vehicle's “behavior” and a vehicle's “trajectory” are used interchangeably. Thus, “behavior estimation” and “trajectory prediction” are also used interchangeably in this description.

In some embodiments, during a training phase, the system analyzes historical driving data including road-agent trajectories to identify a plurality of primitives from which a sequence of primitives can be selected, when the system predicts a road agent's trajectory. In some of those embodiments, a clustering algorithm such as k-means clustering is applied to the historical driving data to identify the plurality of primitives. In other embodiments, techniques such as generic vector quantization methods or categorical probability distributions such as a Gaussian mixture model (GMM) can be used.

A variety of trajectory predictors can be used, depending on the particular embodiment. Examples of predictors include a Kalman filter, a generative adversarial network (GAN), and a fully-connected convolutional neural network (CNN). The embodiments described herein can include one or more of these various types of predictors. In some embodiments employing a GAN, the GAN framework includes a long short-term memory (LS™) component.

In some embodiments, the system supplements the input sensor data by discretizing a roadway into a plurality of segments, encoding roadway-topology data representing the plurality of segments using a graph neural network (GNN), and including the encoded roadway-topology data among the sensor data that the trajectory predictor analyzes.

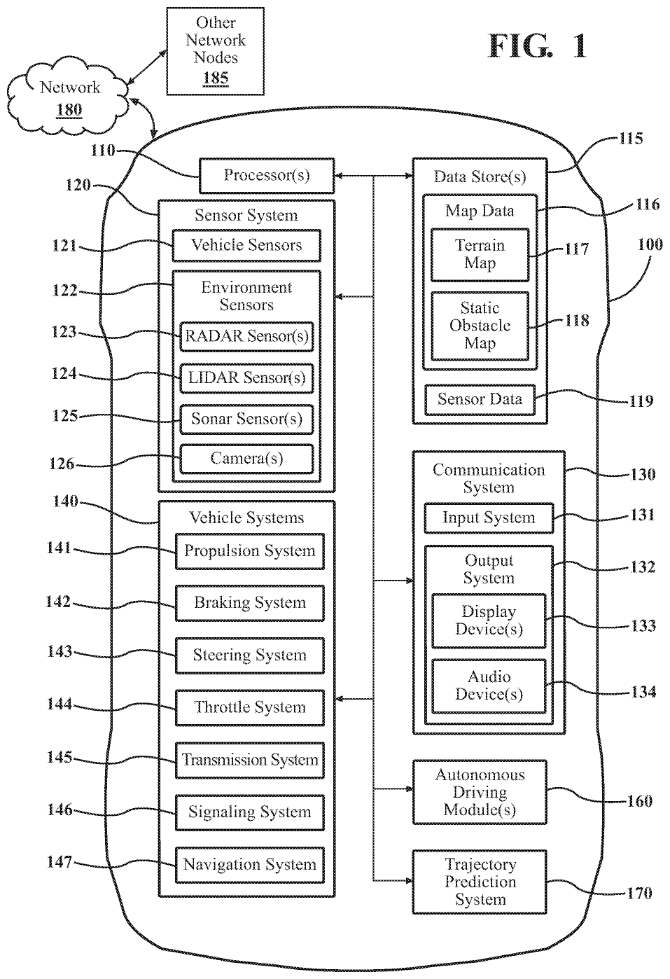

Referring to FIG. 1, an example of a vehicle 100, in which systems and methods disclosed herein can be implemented, is illustrated. The vehicle 100 can include a trajectory prediction system 170 or components and/or modules thereof. As used herein, a “vehicle” is any form of motorized transport. As mentioned above, a “road agent” is an occupier of a roadway, including, without limitation, vehicles, motorcycles, bicycles, scooters, and pedestrians. In one or more implementations, the vehicle 100 can be an automobile. In some implementations, the vehicle 100 may be any other form of motorized transport. In some embodiments, vehicle 100 is capable of operating in a semi-autonomous or fully autonomous mode. In some embodiments, vehicle 100 includes an adaptive cruise control (ACC) system and/or an advanced driver-assistance system (ADAS) (not shown in FIG. 1). The vehicle 100 can include the trajectory prediction system 170 or capabilities to support or interact with the trajectory prediction system 170 and thus benefits from the functionality discussed herein. While arrangements will be described herein with respect to automobiles, it will be understood that implementations are not limited to automobiles. Instead, implementations of the principles discussed herein can be applied to any kind of vehicle, as discussed above. Instances of vehicle 100, as used herein, are equally applicable to any device capable of incorporating the systems or methods described herein.

The vehicle 100 also includes various elements. It will be understood that, in various implementations, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1 (e.g., an ACC system and/or an ADAS). In some arrangements, the vehicle 100 may be implemented without one or more of the elements shown in FIG. 1, including trajectory prediction system 170. While the various elements are shown as being located within the vehicle 100 in FIG. 1, it will be understood that one or more of these elements can be located external to the vehicle 100. Further, the elements shown may be physically separated by large distances. As shown in FIG. 1, vehicle 100 may communicate with one or more other network nodes 185 via network 180. Such other network nodes 185 can include, for example, cloud servers, infrastructure systems (e.g., traffic signals, roadside units (RSUs), etc.), and/or users' mobile devices.

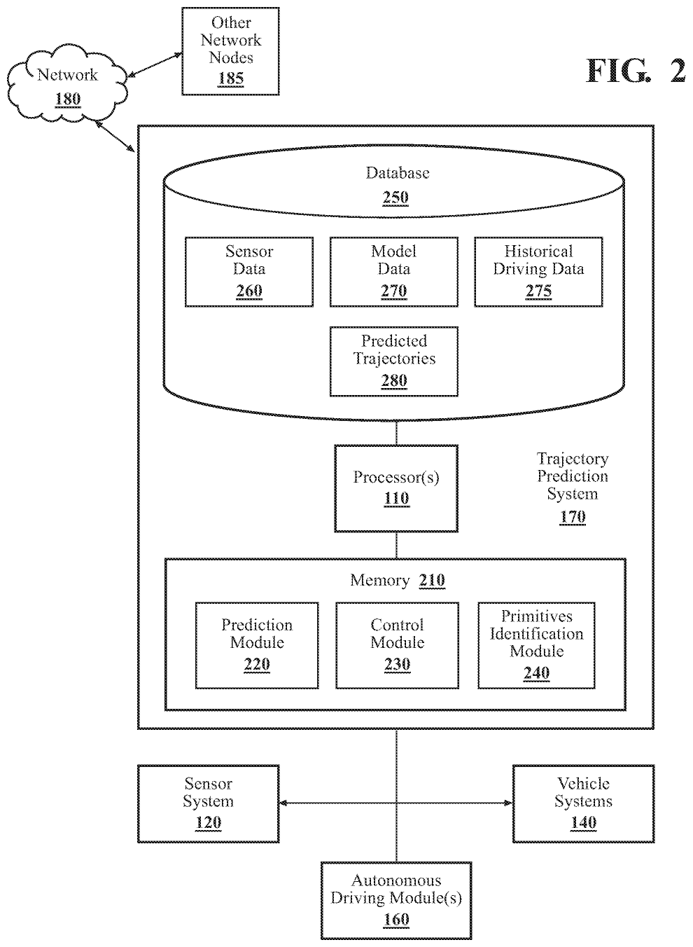

Some of the possible elements of the vehicle 100 are shown in FIG. 1 and will be described in connection with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those skilled in the art, however, will understand that the embodiments described herein may be practiced using various combinations of these elements.

Sensor system 120 can include one or more vehicle sensors 121. Vehicle sensors 121 can include one or more positioning systems such as a dead-reckoning system and a global navigation satellite system (GNSS) such as a global positioning system (GPS). Sensor system 120 can also include one or more environment sensors 122. Environment sensors 122 can include radar sensor(s) 123, Light Detection and Ranging (LIDAR) sensor(s) 124, sonar sensor(s) 125, and camera(s) 126.

Referring to FIG. 2, one embodiment of the trajectory prediction system 170 of FIG. 1 is further illustrated. In this embodiment, trajectory prediction system 170 is shown as including one or more processors 110 from the vehicle 100 of FIG. 1. In general, the one or more processors 110 may be a part of trajectory prediction system 170, trajectory prediction system 170 may include one or more separate processors from the one or more processors 110 of the vehicle 100, or trajectory prediction system 170 may access the one or more processors 110 through a data bus or another communication path, depending on the embodiment.

In one embodiment, memory 210 stores a prediction module 220, a control module 230, and a primitives identification module 240. The memory 210 is a random-access memory (RAM), read-only memory (ROM), a hard-disk drive, a flash memory, or other suitable memory for storing the modules 220, 230, and 240. The modules 220, 230, and 240 are, for example, computer-readable instructions that when executed by the one or more processors 110, cause the one or more processors 110 to perform the various functions disclosed herein.

As shown in FIG. 2, trajectory prediction system 170 can communicate with one or more other network nodes 185 via network 180. As discussed above, such other network nodes 185 can include, for example, cloud servers, infrastructure systems (e.g., traffic signals, roadside units (RSUs), etc.), and/or users' mobile devices. As shown in FIG. 2, trajectory prediction system 170 can also communicate and interact with sensor system 120, vehicle systems 140, and autonomous driving module(s) 160 (refer to FIG. 1).

In some embodiments, trajectory prediction system 170 stores, in a database 250, sensor data 260 output by and received from sensor system 120. Trajectory prediction system 170 can also store, in database 250, model data 270 used by one or more trajectory prediction models. Trajectory prediction system 170 can also store, in database 250, historical driving data 275 that is used in connection with identifying driving primitives and, in some embodiments, training one or more neural networks during a training phase. Trajectory prediction system 170 can also store, in database 250, predicted trajectories 280 output by the trajectory predictor. How these various kinds of data are used in the context of trajectory prediction system 170 is explained below.

Primitives identification module 240 generally includes instructions that cause the one or more processors 110 to analyze historical driving data 275 that includes road-agent trajectories to identify a plurality of primitives from which the sequence of primitives is selected, when the system predicts a road agent's trajectory. As discussed above, in some embodiments the plurality of primitives are identified from the historical driving data 275 using a k-means clustering algorithm. In other embodiments, techniques such as generic vector quantization methods or categorical probability distributions such as a Gaussian mixture model (GMM) can be used. In some embodiments, the identification of primitives may be characterized as a latent-variable mixture model. For example, a primitive called “Left Turn” might be parametrized in terms of different steering angles and modeled as a statistical distribution. In some embodiments, primitives identification module 240 seeks to minimize the number of different data clusters corresponding to distinct driving primitives.

As mentioned above, in some embodiments, trajectory prediction system 170 predicts road-agent trajectories using machine-learning techniques such as a GAN that includes a LS™ component in its framework or a fully-connected CNN. In those embodiments, primitives identification module 240 includes instructions to train one or more neural networks with respect to both the individual primitives themselves and likely sequences of primitives. In some embodiments, prediction module 220 includes a separate neural network for each primitive. In other embodiments, one large neural network is used for all of the primitives. In some embodiments, individual primitives and sequences of primitives are trained separately. In other embodiments, they are trained jointly. In either type of embodiment, the sequences of likely primitives are trained via loss functions. The input historical driving data 275 that primitives identification module 240 uses in training neural networks, in some embodiments, can be categorized as (1) raw sensor data such as image, LIDAR, and radar data; and (2) derivative information such as road-agent poses, a high-definition (HD) map of the surrounding environment and localization information, polynomial encodings of past road-agent trajectories, and contextual information from image space (e.g., showing that the setting is urban, that it is nighttime, that it is raining, etc.).

In some embodiments, primitives identification module 240 carries out the training of the neural networks associated with prediction module 220 in a semi-supervised or unsupervised fashion. In embodiments including semi-supervised training, there can be some manual labeling of primitives a priori. In other embodiments, fully supervised training could be employed, but the manual effort involved could end up being significant.

In some embodiments, primitives identification module 240 is not part of a trajectory prediction system 170 that is deployed in a vehicle 100, and the identification of primitives and primitive sequences (clustering) and the training of one or more neural networks used in trajectory prediction are performed elsewhere than in vehicle 100 (e.g., at a vehicle manufacturer's research and development facility). In those embodiments, the model data 270 including the primitives and the trained neural-network parameters can be downloaded to a trajectory prediction system 170 in a vehicle 100 via network 180. In other embodiments, primitives identification module 240 is included in a trajectory prediction system 170 in a vehicle 100. In those embodiments, the identification of primitives and sequences of primitives (clustering) and the training of neural networks used in trajectory prediction are performed via vehicle 100 itself.

In identifying primitives, primitives identification module 240 takes certain objectives into account. In some embodiments, the primary objectives are (1) interpretability, meaning that each primitive should have an interpretable idea that one could identify from viewing a series of short videos in which road-agent maneuvers (e.g., a right turn) can be observed; and (2) composability, meaning the ability to chain interpretable primitives together into sequences to support the prediction of road-agent trajectories in terms of an ordered sequence of primitives.

In one embodiment, primitives identification module 240 includes instructions that cause each identified (learned) primitive to be structured as a 4-tuple that includes (1) an identifier for the primitive; (2) an optional duration, which can be specified in accordance with a dynamic timescale, as explained above; (3) the relationship of the primitive in question to behaviors from other road agents; and (4) a trajectory-generation or policy function (e.g., if a road agent is slowing down, the policy function could output a trajectory that represents an exponential decrease in speed over time). A variety of different policy functions are possible, depending on the embodiment and the particular type of primitive involved.

Prediction module 220 generally includes instructions that when executed by the one or more processors 110 cause the one or more processors 110 to receive sensor data from one or more sensors in sensor system 120 and to analyze the sensor data to generate a predicted trajectory of a road agent—a road agent external to an ego vehicle 100 or the ego vehicle 100 itself, depending on the embodiment. As discussed above, the predicted trajectory includes a sequence of primitives, and at least one primitive in the sequence of primitives has an associated duration that is determined in accordance with a dynamic timescale. As also discussed above, in some embodiments, the dynamic timescale depends upon one or more predetermined conditions being satisfied. Examples of such predetermined conditions include, without limitation, a road agent in cross-traffic passing by at an intersection, the elapsing of a predetermined time period, a traffic signal changing from one state to another (e.g., red to green or green to red), completing a turn, and arriving at an intersection.

In predicting trajectories, prediction module 220 processes the input sensor data 260, generates the time sequences (samples of time sequences), and then, for each of these, generates the hyperparameters to obtain a distribution of road-agent trajectories. Prediction module 220 also generates a set of possible sequences of primitives and associated time spans. Prediction module 220 then generates the parameters that dictate, for each primitive and time interval, the distribution of predicted behavior for that primitive. In some embodiments, prediction module 220 outputs a confidence estimate in connection with a predicted road-agent trajectory. In some embodiments, prediction module 220 generates confidence estimates for individual durations, policy functions, and feature parameters associated with a given primitive. A confidence estimate, in some embodiments, is in the form of a statistical confidence interval. A duration associated with a primitive can also, in some cases, be expressed in terms of a statistical distribution (e.g., a mean plus or minus a standard deviation).

As discussed above, prediction module 220 can use different kinds of trajectory predictors, depending on the particular embodiment. Examples of candidate predictors include, without limitation, a Kalman filter, a GAN, and a CNN that includes one or more fully-connected layers. In embodiments that include a GAN, the GAN framework can include a LS™ network.

In some embodiments, prediction module 220 receives and processes additional types of sensor data 260 other than that from environment sensors 122 (see FIG. 1). For example, in one embodiment, prediction module 220 discretizes a roadway into a plurality of segments (the segments can be relatively fine or coarse, depending on the embodiment) and encodes roadway-topology data representing the plurality of segments using a graph neural network (GNN). In these embodiments, this encoded roadway-topology data can be included among the sensor data 260 that prediction module 220 analyzes to predict road-agent trajectories. In those embodiments, primitives identification module 240 can train the neural networks, if present, with sample data of that kind, as well.

Control module 230 generally includes instructions that when executed by the one or more processors 110 cause the one or more processors 110 to control one or more aspects of the operation of an ego vehicle 100 based, at least in part, on a predicted trajectory of a road agent. Recall that, in some embodiments, the road agent and the ego vehicle 100 are one and the same vehicle. The one or more aspects of the operation of the ego vehicle 100 can include one or more of steering, acceleration, deceleration, and braking. These aspects of operation can be controlled via the applicable vehicle systems 140 (refer to FIG. 1). Controlling those one or more aspects of vehicle operation can be performed in conjunction with an ACC system, ADAS, semi-autonomous or parallel-autonomy driving system, or a fully-autonomous driving system controlled by autonomous driving module(s) 160.

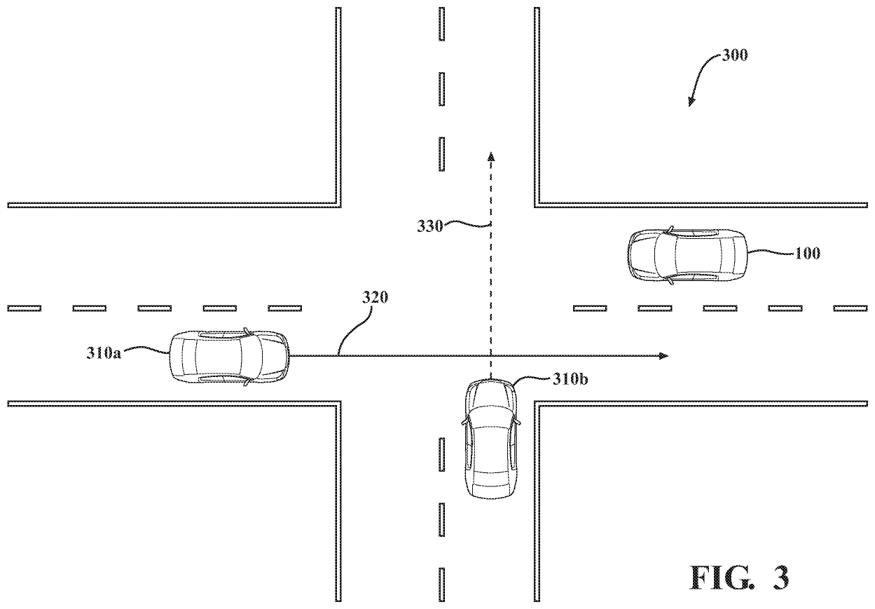

FIG. 3 illustrates a scenario in which a road-agent trajectory is predicted in terms of a sequence of primitives having a dynamic timescale, in accordance with an illustrative embodiment of the invention. In FIG. 3, prediction module 220 of the trajectory prediction system 170 in ego vehicle 100 receives sensor data 260 pertaining to external road agent 310a and external road agent 310b. Prediction module 220 analyzes the sensor data 260 to predict a trajectory for external road agent 310a and a trajectory for external road agent 310b in terms of sequences of primitives. In the case of external road agent 310a, prediction module 220 predicts that external road agent 310a will (1) remain stopped at its present position until external road agent 310b has passed by, after which (2) external road agent 310a will proceed along predicted trajectory 320. In the case of external road agent 310b, prediction module 220 predicts that external road agent 310b will proceed at its current speed of 35 mph along predicted trajectory 330. Once these trajectories have been predicted by prediction module 220, control module 230, in response to those trajectories, controls one or more aspects of the operation of the ego vehicle 100 based, at least in part, on the predicted road-agent trajectories. In this particular example, if the ego vehicle 100 is currently operating in an autonomous driving mode under the control of autonomous driving module(s) 160, prediction module 220 would cause the ego vehicle 100 to slow to a stop before reaching the intersection 300 and then proceed along its planned route after external road agent 310b has passed by. FIG. 3 illustrates only one of many possible scenarios in which a road agent's or ego vehicle's trajectory is predicted by prediction module 220 in terms of a sequence of primitives and in which one or more of those primitives have an associated duration that is determined in accordance with a dynamic timescale.

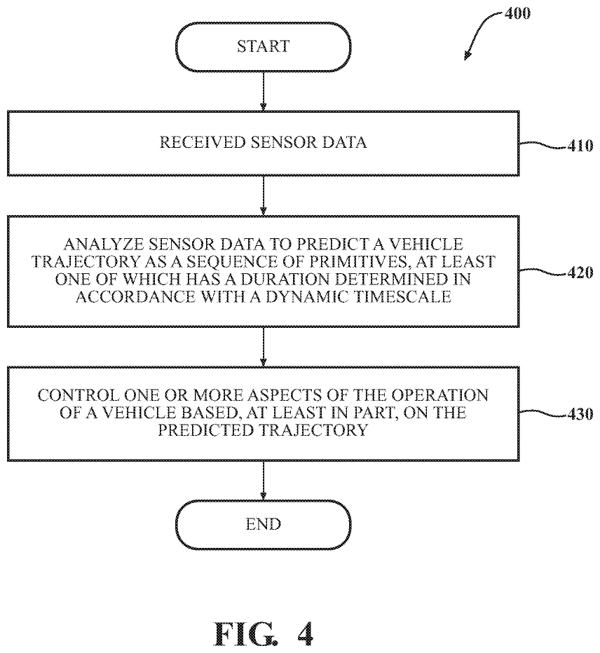

FIG. 4 is a flowchart of a method 400 of predicting a trajectory of a road agent, in accordance with an illustrative embodiment of the invention. Method 400 will be discussed from the perspective of trajectory prediction system 170 in FIG. 2. While method 400 is discussed in combination with trajectory prediction system 170, it should be appreciated that method 400 is not limited to being implemented within trajectory prediction system 170, but trajectory prediction system 170 is instead one example of a system that may implement method 400. Note that some embodiments include additional actions that are not shown in FIG. 4. Those additional actions are discussed below after the discussion of FIG. 4.

At block 410, prediction module 220 receives sensor data 260 from one or more sensors in sensor system 120. As discussed above, the sensors can include, for example, radar sensor(s) 123, LIDAR sensor(s) 124, sonar sensor(s) 125, and camera(s) 126. In some embodiments, the sensor data 260 also includes encoded roadway-topology data representing a plurality of discretized roadway segments. As also discussed above, in some embodiments, prediction module 220 receives and analyzes other types of derivative information such as road-agent poses, an HD map of the surrounding environment and localization information, polynomial encodings of road-agent trajectories, and contextual information from image space (e.g., showing that the setting is urban, that it is nighttime, that it is raining, etc.).

At block 420, prediction module 220 analyzes the sensor data 260 and any other relevant input data to generate a predicted trajectory 280 of a road agent. As discussed above, the predicted trajectory 280 includes a sequence of primitives, and at least one primitive in the sequence of primitives has an associated duration that is determined in accordance with a dynamic timescale. In some embodiments, the dynamic timescale depends upon one or more predetermined conditions being satisfied. Examples of such predetermined conditions include, without limitation, a road agent in cross-traffic passing by at an intersection, the elapsing of a predetermined time period, a traffic signal changing from one state to another, completing a turn, and arriving at an intersection. As discussed above, prediction module 220 can use different kinds of trajectory predictors, depending on the particular embodiment. Examples of candidate predictors include, without limitation, a Kalman filter, a GAN, and a CNN that includes one or more fully-connected layers. In embodiments that include a GAN, the GAN framework can include a LS™ network.

At block 430, control module 230 controls one or more aspects of the operation of an ego vehicle 100 based, at least in part, on the predicted trajectory of the road agent. As discussed above, the one or more aspects of the operation of the ego vehicle 100 can include one or more of steering, acceleration, deceleration, and braking. Also, in some embodiments, the road agent is external to the ego vehicle 100. In other embodiments, the road agent and the ego vehicle 100 are one and the same vehicle (i.e., prediction module 220 predicts a trajectory for the ego vehicle 100 itself, and the ego vehicle 100 is controlled based, at least in part, on that predicted ego-vehicle trajectory). This latter scenario applies, in particular, to ADAS and parallel-autonomy systems.

Depending on the embodiment, method 400 can include additional actions not shown in FIG. 4. As discussed above, in some embodiments, prediction module 220 receives and processes additional types of sensor data 260 other than sensor data from environment sensors 122 (see FIG. 1). For example, in one embodiment, prediction module 220 discretizes a roadway into a plurality of segments (the segments can be relatively fine or coarse, depending on the embodiment) and encodes roadway-topology data representing the plurality of segments using a GNN. In these embodiments, this encoded roadway-topology data can be included among the sensor data 260 that prediction module 220 analyzes to predict road-agent trajectories.

FIG. 1 will now be discussed in full detail as an example vehicle environment within which the systems and methods disclosed herein may be implemented. In some instances, the vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. In one or more arrangement, the map data 116 can include one or more terrain maps 117. The terrain map(s) 117 can include information about the ground, terrain, roads, surfaces, and/or other features of one or more geographic areas. In one or more arrangement, the map data 116 can include one or more static obstacle maps 118. The static obstacle map(s) 118 can include information about one or more static obstacles located within one or more geographic areas.

The one or more data stores 115 can include sensor data 119. In this context, “sensor data” means any information about the sensors that a vehicle is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120. As discussed above, in some embodiments, vehicle 100 can receive sensor data from other connected vehicles, from devices associated with ORUs, or both.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the vehicle 100. The one or more processors 110 and/or the autonomous driving module(s) 160 may control some or all of these vehicle systems 140 and, thus, may be partially or fully autonomous.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine the position and velocity of the vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-4, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™ Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system for predicting a trajectory of a road agent, the system comprising:
one or more sensors;
one or more processors; and
a memory communicably coupled to the one or more processors and storing:
a prediction module including instructions that when executed by the one or more processors cause the one or more processors to:
receive sensor data from one or more sensors; and
analyze the sensor data to generate a predicted trajectory of the road agent, wherein the predicted trajectory includes a sequence of primitives, at least one primitive in the sequence of primitives having an associated duration that is determined in accordance with a dynamic timescale; and
a control module including instructions that when executed by the one or more processors cause the one or more processors to control one or more aspects of operation of an ego vehicle based, at least in part, on the predicted trajectory of the road agent.

2. The system of claim 1, wherein the road agent is one of another vehicle, a motorcycle, a scooter, a bicycle, and a pedestrian.

3. The system of claim 1, wherein the road agent and the ego vehicle are one and the same vehicle.

4. The system of claim 1, wherein the sequence of primitives includes one or more of starting, stopping, following another road agent, passing another road agent, turning left, turning right, changing lanes, and making a U-turn.

5. The system of claim 1, wherein the associated duration that is determined in accordance with a dynamic timescale depends upon one or more predetermined conditions being satisfied.

6. The system of claim 5, wherein the one or more predetermined conditions include one or more of:
a road agent in cross-traffic passing by at an intersection;
an elapsing of a predetermined time period;
a traffic signal changing from a first state to a second state;
completing a turn; and
arriving at intersection.

7. The system of claim 1, wherein the instructions in the prediction module to analyze the sensor data to generate the predicted trajectory of the road agent include instructions to use of one or more of:
a Kalman filter;
a generative adversarial network (GAN); and
a fully-connected convolutional neural network (CNN).

8. The system of claim 7, wherein a framework of the GAN includes a long short-term memory (LSTM) network.

9. The system of claim 1, further comprising a primitives identification module including instructions that when executed by the one or more processors cause the one or more processors to analyze historical driving data that includes road-agent trajectories to identify a plurality of primitives from which the sequence of primitives is selected.

10. The system of claim 9, wherein the instructions in the primitives identification module to analyze historical driving data include instructions to apply one of k-means clustering, generic vector quantization, and categorial probability distributions to the historical driving data.

11. The system of claim 1, wherein the prediction module includes additional instructions to:
discretize a roadway into a plurality of segments; and
encode roadway-topology data representing the plurality of segments using a graph neural network (GNN);
wherein the sensor data includes the encoded roadway-topology data representing the plurality of segments.

12. A non-transitory computer-readable medium for predicting a trajectory of a road agent and storing instructions that when executed by one or more processors cause the one or more processors to:
receive sensor data from one or more sensors;
analyze the sensor data to generate a predicted trajectory of the road agent, wherein the predicted trajectory includes a sequence of primitives, at least one primitive in the sequence of primitives having an associated duration that is determined in accordance with a dynamic timescale; and
control one or more aspects of operation of an ego vehicle based, at least in part, on the predicted trajectory of the road agent.

13. The non-transitory computer-readable medium of claim 12, wherein the associated duration that is determined in accordance with a dynamic timescale depends upon one or more predetermined conditions being satisfied.

14. A method of predicting a trajectory of a road agent, the method comprising:
receiving sensor data from one or more sensors;
analyzing the sensor data to generate a predicted trajectory of the road agent, wherein the predicted trajectory includes a sequence of primitives, at least one primitive in the sequence of primitives having an associated duration that is determined in accordance with a dynamic timescale; and
controlling one or more aspects of operation of an ego vehicle based, at least in part, on the predicted trajectory of the road agent.

15. The method of claim 14, wherein the road agent is one of another vehicle, a motorcycle, a scooter, a bicycle, and a pedestrian.

16. The method of claim 14, wherein the road agent and the ego vehicle are one and the same vehicle.

17. The method of claim 14, wherein the associated duration that is determined in accordance with a dynamic timescale depends upon one or more predetermined conditions being satisfied.

18. The method of claim 14, further comprising:
analyzing historical driving data that includes road-agent trajectories to identify a plurality of primitives from which the sequence of primitives is selected.

19. The method of claim 18, wherein the analyzing historical driving data includes applying one of k-means clustering, generic vector quantization, and categorial probability distributions to the historical driving data.

20. The method of claim 14, further comprising:
discretizing a roadway into a plurality of segments; and
encoding roadway-topology data representing the plurality of segments using a graph neural network (GNN);
wherein the sensor data includes the encoded roadway-topology data representing the plurality of segments.
